(19) United States
(12) Patent Application Publication
(10) Pub. No.: US 2012/0305528 A1
(43) Pub. Date: Dec. 6, 2012

(54) REMOVABLE COATING AND RESIN SYSTEM AND METHOD OF USING THE SAME

(76) Inventors: Moore Greenberg, Valley Village, CA (US); Kristopher M. Felice, Wolverine Lake, WI (US)

(21) Appl. No.: 13/150,949

(22) Filed: Jun. 1, 2011

(51) Int. Cl. C08K 3/28; C09D 133/14; B44C 1/22; C08K 3/34

(52) U.S. Cl. 216/83; 524/428; 524/445; 524/556; 524/522; 156/345.11

(57) ABSTRACT

The illustrated embodiments include a selectively removable marking product composed of an aqueous solution of at least one resin complex of polyethyleneimine (PEI) characterized by a total amine number-to-carboxylic acid number ratio in the range of 1/3 to 1 inclusive, an alkaline additive and at least one paint additive. The illustrated embodiments also include a system for semipermanently applying a marking product to the surface of an article to decorate, illustrate or color the article and then selectively removing the marking product therefrom which includes the steps of coating the surface of the article with the marking product having the composition disclosed above, air drying the marking product on the surface to provide a semipermanent coating, and at a later time selectively removing the semipermanent coating by application thereto of an alkaline solution.

### BACKGROUND OF THE INVENTION

1. Field of the Technology

The invention relates to the field of removable paints or coatings, a system for removable paints or coatings and a method for applying removable paints or coatings onto arbitrary surfaces. The system can be used to provide removable paints or coatings onto a wide variety of hard or soft surfaces for purposes of decoration or illustration, which can then be readily removed as desired.

2. Description of Prior Technologies

The need for a removable paint formulation that can be applied onto a surface or over another paint and subsequently removed without damaging the underlying surface or paint is well known. A removable durable paint or coating for hard surfaces and a paint remover for removing the paint is disclosed in Warren et. al. “A Water Based Removable Paint Formulation and System,” WO 2007/059150. The removable paint is a dispersion of a formulation of acrylic polymers and a urethane polymer. The combination is neutralized with an alkali. The proportion between the acrylic polymers can be adjusted to achieve the desired characteristics of the paint and the amount of acrylic polymer present can be adjusted in relationship to the urethane polymer to achieve the desired characteristics. Pigment or dyes can be added to the mixture to make the coating a paint. Effect particles, such as reflective beads can be added to the mixture to provide reflective qualities for applications to highways and airports. Various other effects can be achieved, such as by addition of iridescent pearl pigment or ultraviolet light reflective pigments. The removable paints and coatings can be removed by contact with alkaline solutions that contain a surfactant. The remover solution is applied to the coating or paint and brushed or otherwise agitated and allowed to set for a few minutes and then removed by water. Another type of remover composition is a combination of dibasic esters and thickeners.

### BRIEF SUMMARY OF THE INVENTION

The illustrated embodiments include a selectively removable marking product composed of an aqueous solution of at least one resin complex of polyethyleneimine (PEI) characterized by a total amine number-to-carboxylic 1acid number ratio in the range of 1/3 to 3 inclusive, an alkaline additive and at least one paint additive.

The marking product may include a plurality of different resin complexes of polyethyleneimine (PEI). In one embodiment the alkaline additive comprises ammonium hydroxide.

In the illustrated embodiments the paint additive includes one or more elements from the group consisting of titanium dioxide and clay.

The paint additive may further include metallic or reflective flakes, glitter, color shifting pigments or formulated paints.

The resin complex of polyethyleneimine (PEI) includes an acrylic polymer or acrylic resin in the illustrated embodiments.

In the illustrated embodiments the acrylic polymer or acrylic resin is an acrylic emulsion neutralized by a solution of polyethyleneimine. However, it is to be expressly understood that many other polymers are known in the art as possible substitutes for the acrylic polymer or acrylic resin, such as urethane polymers and the like.

In the illustrated embodiments the plurality of different resin complexes with polyethyleneimine (PEI) are present in the marking product in the range of 1 to 50 percent by weight when in a liquid form. In the case of a dry film, the resin complex with polyethyleneimine (PEI) percentage by weight would tend to approach 100%.

In another one of the illustrated embodiments the plurality of different resin complexes with polyethyleneimine (PEI) are present in the marking product with acrylic emulsions in the range of 1 to 50 percent by weight when in a liquid form. In the case of a dry film, the acrylic resin complex with polyethyleneimine (PEI) percentage by weight would tend to approach 100%.

In other ones of the illustrated embodiments the plurality of different resin complexes with polyethyleneimine (PEI) are present in the marking product as acrylic emulsions collectively in the range of 10 to 50 percent by weight and polyethyleneimine in the range of 10 to 50 percent by weight when the marking product is in a liquid form.

In one of the illustrated embodiments the plurality of different resin complexes with polyethyleneimine (PEI) are present in the marking product as at least two acrylic emulsions, one with an acrylic emulsion acid number in the range of 50 to 200 and present in the marking product in the range of 1 to 50 percent by weight when the marking product is in a liquid form and the other of the at least two acrylic emulsions with an acrylic emulsion acid number in ₜhe range of 50 to 200 and present in the marking product in the range of 1 to 50 percent by weight when the marking product is in a liquid form, and where the polyethyleneimine amine number is in the range of 100 to 1000 and present in the marking product in the range of 1 to 50 percent by weight.

The illustrated embodiments include a method of selectively painting a surface comprising coating the surface with the marking product as disclosed above.

The method includes the steps of selectively removing the marking product by neutralizing the marking product with an alkali, and washing or scrubbing the neutralized marking product off the surface.

The step of selectively removing the marking product by neutralizing the marking product with an alkali includes the step of applying a solution of sodium bicarbonate to the marking product on the surface.

The step of coating the surface with the marking product includes the step of painting at least part of a hard or soft surface, including one made of fabrics comprised of natural or synthetic fibers, or leathers, including shoes, shirts, hats, pants, backpacks, luggage, articles made of plastic, including lunch boxes, phones, laptops, snowboards, skies, including articles made of metals, including cars, motorcycles, trucks boats, RV's, trailers, bicycles; or articles made of construction materials, including interior or exterior walls.

The illustrated embodiments also include a system for semipermanently applying a marking product to the surface of an article to decorate, illustrate or color the article and then selectively removing the marking product therefrom which includes the steps of coating the surface of the article with the marking product having the composition disclosed above, air drying the marking product on the surface to provide a semipermanent coating, and at a later time selectively removing the semipermanent coating by application thereto of an alkaline solution.

The system includes the step of providing a kit including the marking product, an applicator for the marking product, and at least one ingredient for making the alkaline solution.

The system further includes the step of providing the kit with at least one transfer to transfer a design to the surface of the article.

The system further includes the step of providing the kit with means for enabling a user to generate a design with a computer to manufacture at least one transfer to transfer a design to the surface of the article.

The system further includes the step of providing metallic or reflective flakes, glitter, color shifting pigments or formulated paints with the kit.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

### DETAILED DESCRIPTION OF THE PREFERRED EMBODIMENTS

The illustrated embodiment includes a marking, painting, decorating or illustrating system (hereinafter called the “marking product”), which uses a removable paint or marker to apply a colored design to a wide variety of types of surfaces or substrates, while remaining easily removable by a neutralizing solution which has low environmental impact. The marking product can be applied by a brush, spray, marker, roller, or any other type of applicator now known or later devised. The marking product is supplied in various tints or colors and is applicable to or bonds with many different kinds of hard or soft surfaces such as but not limited to: articles made of fabrics (natural or synthetic) or leathers, such as shoes, shirts, hats, pants, backpacks, luggage; articles made of plastic, such as lunch boxes, phones, laptops, snowboards, skies; articles made of metals, such as cars, motorcycles, trucks, boats, RV's, trailers, bicycles, or other marine, aviation, and freight vehicles; and articles made of construction materials, such as interior and exterior walls. The kinds of articles and types of surfaces to which the marking product can be applied and adhered is nearly limitless and no exhaustive listing can practically be supplied. Virtually any surface or substrate on which paint or coatings are applied for decoration, illustration, signage or any other functional or aesthetic purpose can be used.

After application of or treatment with a neutralizing solution of the marked surface, the applied marking product, which is otherwise considered as permanent, can easily be removed from the unaffected substrate and any underlying paint or coating surface which may have been in place when the marking product was applied. Any kind of wash or removing fluid, such as water, may be employed after or simultaneously with the neutralizing solution to effect removal of the marking product. As disclosed below the illustrated neutralizing solution is a basic aqueous solution of sodium bicarbonate, but any alkaline or basic solution will be effective to at least some degree as a removal solution. The basic aqueous solution of sodium bicarbonate need not have any particular pH value at or above a predetermined minimum, but a pH of at least approximately 8.5 is preferred. A wash and/or mechanical scrubbing may or may not be employed in addition to or with the neutralizing solution.

In the meantime, the application of neutral or acidic cleaning solutions applied for other reasons to the marked surface will generally not affect the deposition of the marking product. Should it become desirable to wash or clean the surface having the marker product applied to it, it can be washed using any acidic cleaning solution. For example, if a design is applied to an article of clothing and it is desired to wash the article without destroying the design, it is preferable that the laundry soaps, which ordinarily might be slightly basic, be acidified to avoid degradation or destruction of the design. The addition of vinegar, for example, to the laundry soap solution will prevent substantial destruction of the design.

Metallic or reflective flakes, glitter or color shifting pigments or dry pigments, dyes or pigments dispersions. Paints by Duplicolor®, a trademark of Dupli-Color Products Company of Cleveland, Ohio, can be mixed in with the marking product to obtain any tints or colors desired and will be removed with the neutralizing solution and wash. Once the marking product air dries, other markings or paints can be applied on top of the dried marking product and will be removed along with the marking product once the neutralizing solution is applied. For example, additional designs or markings can be applied on top using markers such as sold under the trademark, Sharpie®, by Sanford, L. P, Newell Operating Company of Oakbrook, Ill.

One of the uses of the marking system contemplated is the use by businesses to frequently change their advertising message in a more cost effective manner for their vehicle fleets (vehicles, trailers, buses, marine and airlines). Similarly, another end use is by building owners to change an exterior façade for residential and commercial buildings to provide seasonal and/or promotional messages. Still another use is as part of an art kit where children or adults may be use the marking product and marking system to provide removable designs to their possessions and living environments. For example, children can be freely invited to decorate the walls in their own bedrooms or classrooms with the assurance that the designs, which are otherwise resistant to removal by water, for example, can easily later be completely removed by use of the neutralizing solution with a nontoxic wash without any damage to underlying surface, its paint or coatings. The designs may be applied using the marking product free hand or can be applied in the form of stencils or applied by the user from professionally or conventionally prepared transfers or end-user, computer generated transfers. The number and variety of end uses are nearly unlimited and no closed listing of such uses can be practically supplied.

The marking product of the removable pigment coating system of the illustrated embodiment is formulated with commercially available or conventional resin complexes of polyethyleneimine (PEI). Equation [1] defines illustrative ratios for the marking product:

(Sum of the Amine number mg KOH/g PEI×grams of PEI)/(Sum of the Carboxylic acid number mg KOH/g)=1/3 to 3. [1]

Equivalent weight is a calculated value determined from the amine number, also known as the amine value or amine alkalinity. The amine number is determined by titration of the amine acetate ion by a dilute, typically 1N HCl solution. For pure material, the amine number can be calculated using the molecular weights of the pure compound and KOH (56.1 g/mol). For example,

a) Amine Number (by titration):

(A×N×56.1)/g sample=Amine Number (mg KOH/g)

Where

A=mL of HCl titrant consumed

N=Normality of HCl titrant

g=sample weight in grams

b) Amine Number (of pure material):

1000×56.1/molecular weight of material=Amine Number (mg KOH/g)

c) Equivalent Weight can be determined by:

(56.1×1000)/Amine number=Equivalent Weight

Using a composition of constituents for the marking product in the range of equation [1], the air dried coating left by the marking product can be removed with neutralizing solution, namely an alkali solution, such as a saturated aqueous solution sodium bicarbonate. The ease of removability of the dried coating of the marking product by the neutralizing solution can be manipulated by manipulating the ratio of carboxylic acid to amine.

### EXAMPLES

In the illustrated embodiment, 6.4 g of Joncryl® 142, an acrylic polymer or acrylic resin used as a general purpose, acrylic colloidal emulsion designed as a sole vehicle for carbon black inks and as a letdown vehicle for organic colors, a product of S. C. Johnson & Son, inc. of Racine, Wis., 3.36 g of water, and 0.36 mL, 28-32 wt %. ammonium hydroxide were added to each of four vials to form a milky emulsion. On addition and stirring of the ammonium hydroxide, the milky emulsion of water arid Joncryl® 142 became a clear viscous solution. Varying amounts of 5% polyethyleneirnine in water were added to the vials A-D, namely:

A: 6.5 mL

B: 7.5 mL

C: 9.0 mL

D: 12.0 mL

Samples from all four vials A-D were spread onto corresponding glass microscope slides and allowed to dry for an hour at 55° F., resulting in hard coatings. The samples were immersed in water for an hour. The coatings softened slightly, and turned from clear to white. After two and one half hours in water, there was no apparent change from the one-hour immersion. The coatings were slightly rubbery, but in general adhered well to the glass substrate and were resistant to mild abrasion. Samples C and D appeared to be slightly harder than samples A and B. Sample C appeared differently from the other samples; after standing in water sample C was not as white as the other coatings of samples A, B and D.

Portions of Sample C (2.0 g each) were weighed into five vials C1-C5 and zinc oxide was added in the following weights to each vial and mixed well to form a paint, namely:

C1: 0.10 g

C2: 0.20 g

C3: 0.40 g

C4: 0.08 g

C5: 0.05 g

Samples C1-C5 of the resulting paint were applied to corresponding glass microscope slides. The paint was dried for one hour at 55° F. All five samples C1-C5 gave a solid hard coating. Samples C1, C2, and C3 were observably less opaque than C3 and C4. The whiteness of C3 and C4 was similar, but C3 had a smoother coating that was more scratch resistant than C4. All five dried samples C1-C5 were placed in water. After soaking in water for two hours, the coatings were still hard and there was no visible change. The samples C1-C5 were immersed in water overnight. The samples looked the same, but there was a slight softening of the coating. The coating was still intact, and fairly hard, but yielded slightly when pressed with a spatula The coating still adhered well to the glass substrate.

In the previous preparations, mixing the Joncryl®142 with water and ammonium hydroxide according to the published BASF recommendations, namely neutralizing the Joncryl® 142 supplied in the acidic form and diluting it with a solution of the formulation suggested by BASF before subsequent use in formulations, resulted in a mixture that was very viscous and difficult to stir. It may be advantageous to avoid this stage so that mixing is easier and less expensive on scaled-up production. If ammonium hydroxide is added to the polyethyleneimine solution, then the Joncryl®142 added by stirring, that the viscous intermediate material can be avoided.

28% ammonium hydroxide (0.38 mL) was added to 5% polyethyleneimine in water (9.0 g). Joncryl®142 (6.3 g) was added by stirring. Small amounts of a white viscous gel formed during the addition, but on further mixing a homogenous mixture was obtained. The viscosity was much lower than that of the pre-made Joncryl®142/water/ammonium hydroxide gel produced by the BASF procedure. This order of addition made the preparation of the polymer/binder solution much easier to prepare. Zinc oxide (3.50 g) was added and the sample mixed well to give a Sample E. Sample E was spread on glass microscope slides and allowed to air dry. After air drying Sample E slides overnight, the coatings were hard.

On placing the samples A-E in saturated sodium bicarbonate solution, the coating softened and came off the glass substrate within a few minutes. Samples A-E placed in water remained hard. One of the dried samples E was dipped quickly into saturated sodium bicarbonate solution, and then allowed to air dry. This gave a hard coating that, when placed in water, quickly softened to a weakly adhered gel that fell of the glass with slight agitation. While Sample E gave hard coatings arid good coverage on a horizontal surface, on a vertical surface, much of the mixture ran off, leaving a thin coating. It may be desirable to increase the viscosity of the mixture to give better coverage of non-horizontal surfaces. The use of a rheology modifier during coating formulation would be necessary. The above paint mixtures have a variety of viscosities, some thin and some very thick, but they have not had an intermediate viscosity that would spread well and still stick to vertical surfaces.

The following formulation increases the viscosity of a sample, such as Sample E, by decreasing the amount of water in the mixture. 28% ammonium hydroxide (0.38 mL) was added to 10% polyethyleneimine in water (4.50 g). Joncryl®142 (6.3 g) was added by stirring. A thick white mixture was obtained. The mixture was fairly easy to stir and the viscosity did not increase above that of the final mixture. The thick mixture did entrain air bubbles during mixing, and these remained in the mixture because of the higher viscosity. Zinc oxide (3.5 g) was added to the mixture and mixed well to give paint Sample F. The sample F was spread on glass microscope slides. Unlike previous preparations, the sample was viscous enough to stick to vertical surfaces without running, giving a paint-like coating. Sample F was dried at 55° F. which resulted in a hard coating. The coating was rough with small lumps, appearing as if the pigment was agglomerated. This was not unexpected, because the pigments were added to the mixture and not appropriately dispersed.

Two more batches of the binder resin were prepared: 28% ammonium hydroxide (0.38 mL) was added to 10% polyethyleneimine in water (4.50 g). Joncryl®142 (6.3 g) was added by stirring. One was labeled Sample G. The second was labeled Sample H. Zinc oxide (3.5 g) was added. Sample G (no zinc oxide) was a milky white viscous material, homogeneous with no lumps or separate phase. Sample H (with zinc oxide) was noticeably less viscous than Sample G and contained lumps of white pigment. This lumpy pigment is similar to what had been observed when polymer separated from the mixture was a separate phase. It is possible that the zinc oxide is binding with some of the ammonium hydroxide, causing the some of the polymer to separate out. This polymer is then binding together to the zinc oxide into the lumps observed. Additional 28% ammonium hydroxide (0.18 mL) was added to Sample H. After mixing well it, appeared that the lumps dispersed to give a more uniform mixture. This sample H2 was still less viscous than Sample G.

Sample D gave a smooth hard opaque coating, but was rather non-viscous and did not cover a vertical surface well. More concentrated samples contained lumps of zinc oxide pigment. The following experiments were to reproduce and improve on the ID results. Samples I and J: Joncryl® 142 (6.4 g), water (3.36 g) and concentrated ammonium hydroxide (0.36 mL) were added to each vial. On adding the ammonium hydroxide and stirring, the milky emulsion became a clear viscous solution. 5% polyethyleneimine in water (9.0 g) was added to Sample I. 10% polyethyleneimine in water (4.5 g) was added to Sample J. The samples were shaken well.

Samples K and L: 5% polyethyleneimine in water (9.0 g) was added to Sample K. 10% polyethyleneimine in water (4.5 g) was added to Sample L. Water (3.6 mL) and 28% ammonium hydroxide (0.38 mL) were added to each vial. The samples were shaken well. [65] Zinc oxide (3.5 g) was added to each of the four samples I, J, K and L, and mixed well. All four samples I, J, K and L, had well dispersed zinc oxide with no clumping. Samples of each were spread on glass microscope slides and allowed to dry. After drying overnight, these four samples I, J, K and L did not result in as good of coatings as expected. Where the material was spread thin, the dried coating was adhered to the glass substrate, but where the sample was pooled thicker, the sample dried to a crumbly coating that did not adhere to the glass. Sample L appeared to give the best coating, it was cracked, but adhered to the glass. It appeared that the coating shrank as it dried. There may have been too much pigment in the samples. It is not clear why the samples did not result in as good of coatings as Samples D3 and H, which were prepared in a very similar manner. Since the roughly prepared coating samples showed promise, the concept of complex carboxylic functional resin with polyethyieneimine was used in the formulation of a complete coating.

Acrylic Emulsion (Acrylic Acid Emulsion) Plus Polyethyleneimine:

A sample of the emulsion (12.5 g, commercially available acrylic emulsion with an acid number of 130) was neutralized using a solution of 50% polyethyleneimine (0.85 g Fluka P3142® from Fluka A G, Chemische Fabrik of St. Gallen, Switzerland, in 6.5 g of water). On mixing, the mixture became viscous and a sticky plastic like material separated from the water phase. The material was stringy and formed sticky globs. Some of the material was spread on microscope slides to dry, but the material did not spread evenly. The sticky material was spread onto microscope slides. Based on this preliminary idea and proof of concept commercial resins were sourced. Several acid functional commercially available resins were evaluated for use in complexes with polyethyleneimine. The resins selected were Joncryl 142®, Joncryl HPD 296®, Esi-cryl 687® of Cook Composites And Polymers Co of Kansas City, Mo. The illustrated embodiments of the invention are not limited to these resin samples and can be used with any carboxylic functional resin. The polyethyleneimine used throughout the feasibility stage was supplied through Sigma Aldrich of St. Louis, Mo. The polyethyleneimine resin used was Lupasol P® from BASF Aktiengesellschaft of Ludwigshaven am Rhein, Germany. Included in the table below is an illustrative removable base paint formula based on the the polyacrylic and polyethyleneimine mixture.

A first example of an illustrated formula for the marking product is in Table 1. A second example of a formula for commercial production of the marking product is shown in Table 2. Conventional paint or coating additives have been included to render the marking product more adherent, smooth and uniform for application for general surfaces of arbitrary orientation. The included additives are by no means exhaustive and many others can be substituted or included as is well known to those of ordinary skill in the art of paints and coatings.

The acid value (or “neutralization number” or “acid number” or “acidity”) is the mass of potassium hydroxide (KOH) in milligrams that is required to neutralize one gram of chemical substance. The acid number is a measure of the amount of carboxylic acid groups in a compound, such as a fatty acid, or in a mixture of compounds. In a typical procedure, a known amount of sample dissolved in organic solvent is titrated with a solution of potassium hydroxide with known concentration and with phenolphthalein as a color indicator.

TABLE 1
Theoretical Removable Base Formula

| Raw Material | Wt (g) |
|---|---|
| Water | 100 |
| Acrylic Emulsion Acid Number (130) | 100 |
| Acrylic Emulsion Acid Number (141) | 30 |
| Ammonium Hydroxide | 30 |
| Titanium Dioxide | 125 |
| Clay | 75 |
| (Grind to Hegman >6) | — |
| Acrylic Emulsion Acid Number (130) | 210 |
| Polyethyleneimine Amine Number | 23 |
| Water | 20 |
| Ammonium Hydroxide | 10 |

A Hegman gauge, sometimes referred to as a grind gauge or grindometer, is used to determine how finely ground are the particles of pigment (or other solid) dispersed in a sample of paint or other liquid. The gauge is comprised of a steel block with a series of very small parallel grooves machined into it. The grooves decrease in depth from one end of the block to the other, according to a scale stamped next to them. A typical Hegman gauge is 170 mm by 65 mm by 15 mm, with a channel of grooves running lengthwise, 12.5 mm across and narrowing uniformly in depth from 100 μm to zero. A Hegman gauge is used by puddling a sample of paint at the deep end of the gauge and drawing the paint down with a flat edge along the grooves. The paint fills the grooves, and the location where a regular, significant “pepperyness” in the appearance of the coating appears marks the coarsest-ground dispersed particles. The reading is taken from the scale marked next to the grooves, in dimensionless “Hegman units” and/or mils or micrometres. Determining the fineness of a paint's grind is important, because a too-coarse grind may reduce the paint's color uniformity, gloss, and opacity. The Hegman gauge is widely used for this purpose because it requires minimal skill and only a few seconds' work.

In a commercial embodiment, the marking product may have formulation as provided below. It is to be understood that the illustrated embodiment may include other elements and the proportions may be varied according to conventional principles without departing from the spirit and scope of the invention.

| Raw Material | Wt (g) |
|---|---|
| Water | 100.0 |
| Acrylic Emulsion Acid Number (110) | 100.0 |
| Acrylic Emulsion Acid Number (141) | 30.1 |
| Ammonium Hydroxide | 30.0 |
| Silicone Polyether Block Copolymer | 25.0 |
| Titanium Dioxide | 125.0 |
| Clay | 75.0 |
| (Grind to Hegman >6) | — |
| Acrylic Emulsion Acid Number (130) | 210.0 |
| Polyethyleneimine Amine Number | 20.1 |
| Water | 20.0 |
| Ammonium Hydroxide | 10.0 |

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A selectively removable marking product comprising:
an aqueous solution of at least one resin complex of polyethyleneimine (PEI) characterized by a total amine number-to-carboxylic acid number ratio in the range of 1/3 to 1 inclusive,
an alkaline additive; and
at least one paint additive.

2. The marking product of claim 1 where a plurality of different resin complexes of polyethyleneimine (PEI) are present.

3. The marking product of claim 1 where the alkaline additive comprises ammonium hydroxide.

4. The marking product of claim 1 where the at least one paint additive comprises one or more elements from the group consisting of titanium dioxide and clay.

5. The marking product of claim 4 where the at least one paint additive further comprises metallic or reflective flakes, glitter, color shifting pigments or formulated paints.

6. The marking product of claim 1 where the resin complex of polyethyleneimine (PEI) comprises an acrylic polymer or acrylic resin.

7. The marking product of claim 6 where the acrylic polymer or acrylic resin is an acrylic emulsion neutralized by a solution of polyethyleneimine.

8. The marking product of claim 1 where a plurality of different resin complexes with polyethyleneimine (PEI) are present in the range of 1 to 50 percent by weight when the marking product is in a liquid form.

9. The marking product of claim 1 where a plurality of different resin complexes with polyethyleneimine (PEI) are present as acrylic emulsions collectively in the range of 1 to 50 percent by weight when the marking product is in a liquid form.

10. The marking product of claim 1 where a plurality of different resin complexes with polyethyleneimine (PEI) are present as acrylic emulsions collectively in the range of 10 to 50 percent by weight and polyethyleneimine in the range of 10 to 50 percent by weight when the marking product is in a liquid form.

11. The marking product of claim 1 where a plurality of different resin complexes of polyethyleneimine (PEI) are present as at least two acrylic emulsions, one with an acrylic emulsion acid number in the range of 50 to 20 and present in the range of 1 to 50 percent by weight when the marking product is in a liquid form and the other of the at least two acrylic emulsions with an acrylic emulsion acid number in the range of 50 to 200 and present in the range of 1 to 50 percent by weight when the marking product is in a liquid form, and where the polyethyleneimine amine number is in the range of 100 to 1000 and present in the range of 1 to 50 percent by weight when the marking product is in a liquid form.

12. A method of selectively painting a surface comprising coating the surface with the marking product of claim 1.

13. The method of claim 12 further comprising selectively removing the marking product by neutralizing the marking product with an alkali, and washing or scrubbing the neutralized marking product off the surface.

14. The method of claim 13 where selectively removing the marking product by neutralizing the marking product with an alkali comprises applying a solution of sodium bicarbonate to the marking product on the surface.

15. The method of claim 12 where coating the surface with the marking product comprises painting at least part of a hard or soft surface, including one made of fabrics or leathers, including shoes, shirts, hats, pants, backpacks, luggage, articles made of plastic, including lunch boxes, phones, laptops, snowboards, skies, including articles made of metals, including cars, motorcycles, trucks boats, RV's, trailers, bicycles; or articles made of construction materials, including interior or exterior walls.

16. A system for semipermanently applying a marking product to the surface of an article to decorate, illustrate or color the article and then selectively removing the marking product therefrom comprising:
coating the surface of the article with the marking product having the composition of claim 1;
air drying the marking product on the surface to provide a semipermanent coating; and
at a later time selectively removing the semipermanent coating by application thereto of an alkaline solution.

17. The system of claim 16 further comprises providing a kit including the marking product, an applicator for the marking product, and at least one ingredient for making the alkaline solution.

18. The system of claim 17 further comprising providing the kit with at least one transfer to transfer a design to the surface of the article.

19. The system of claim 17 further comprising providing the kit with means for enabling a user to generate a design with a computer to manufacture at least one transfer to transfer a design to the surface of the article.

20. The system of claim 16 further comprising providing metallic or reflective flakes, glitter, color shifting pigments or formulated paints with the kit.
